(19) United States
(12) Patent Application Publication
(10) Pub. No.: US 2007/0104849 A1
(43) Pub. Date: May 10, 2007

(54) Stable acidic beverage emulsions and methods of preparation

(76) Inventors: David Julian McClements, Northampton, MA (US); Eric Andrew Decker, Sunderland, MA (US)

Correspondence Address: REINHART BOERNER VAN DEUREN S.C.;ATTN: LINDA KASULKE, DOCKET COORDINATOR, 1000 NORTH WATER STREET, SUITE 2100, MILWAUKEE, WI, 53202, US

(21) Appl. No.: 11/528,758

(22) Filed: Sep. 28, 2006

Related U.S. Application Data
(60) Provisional application No. 60/721,279, filed on Sep. 28, 2005.

(51) Int. Cl. A23L 2/00

(52) U.S. Cl. 426/590

(57) ABSTRACT

Beverage compositions and related methods, including using emulsion coating components for degradative stability.

This invention claims priority benefit from application Ser. No. 60/721,279 filed Sep. 28, 2005, the entirety of which is incorporated herein by reference.

The United States Government has certain rights to this invention pursuant to grant no. 2002-35503-12296 from the Department of Agriculture to the University of Massachusetts.

In general, the term “beverage emulsion” refers to any oil-in-water emulsion consumed as a beverage, e.g., tea, coffee, milk, fruit drinks, dairy-based drinks, drinkable yogurts, infant formula, nutritional beverages, sports drinks and colas. More specifically, it can be used to refer to medium- and high-acid beverages (pH 2-6.5) that are usually taken cold (e.g., fruit, vegetable, tea, coffee and cola drinks). This group of products has a number of common manufacturing, compositional and physicochemical features. Beverage emulsions are normally prepared by homogenizing an oil and aqueous phase together to create a concentrated oil-in-water emulsion, which is later diluted with an aqueous solution to create the finished product. The oil phase in beverage emulsions normally contains a mixture of non-polar carrier oils (e.g., terpenes), flavor oils, and weighting agents, whereas the aqueous phase typically contains water, emulsifier, sugar, acids and preservatives. The aqueous phase in finished beverage emulsions is normally quite acidic (pH 2.5 to 4.0). Finished beverage products have slightly turbid or “cloudy” appearances because they contain relatively low oil droplet concentrations (typically 0.01-0.1 wt %). They also have Theological characteristics that are dominated by the continuous phase, rather than the presence of the droplets. Beverage emulsions are thermodynamically unstable systems that tend to breakdown during storage through a variety of physicochemical mechanisms, including creaming, flocculation, coalescence and Ostwald ripening. The long-term stability of beverage emulsions is normally extended by adding a variety of stabilizers to retard these processes, e.g., emulsifiers, thickening agents and weighting agents, during processing or homogenization.

The emulsifier most commonly used in commercial beverage emulsions is gum arabic. Gum arabic (also known as gum acacia) is a polymeric material usually derived from the natural exudate of trees from the genus Acacia. Gum arabic is usually an effective emulsifier because of its surface activity, high water-solubility, low solution viscosity and ability to form a protective film around emulsion droplets. Nevertheless, it has a relatively low surface-activity (when compared to surfactants and proteins), necessitating use in a relatively high amount. For example, as much as 20% gum arabic may be required to produce a stable 12.5 wt % oil-in-water emulsion, whereas less than 1% whey protein isolate would be needed. In addition, there are considerable problems associated with obtaining a reliable source of consistently high quality gum arabic, prompting many beverage manufacturers to investigate other emulsifier sources.

It has been proposed that various types of food protein could be used as emulsifiers in acidic beverage emulsions, e.g., whey proteins, soy proteins, caseins, plant proteins, fish proteins, meat proteins or egg proteins. Such proteins can be used at a much lower concentration than gum arabic to stabilize emulsions (e.g., less than 0.1 g of protein is normally required to stabilize 1 g of oil, whereas more than 1 g of gum arabic is needed to stabilize 1 g of oil). In addition, the compositional and functional properties and supply reliability of protein ingredients have been shown, generally, to be much better than that of gum arabic. Nevertheless, many protein-stabilized emulsions have fairly poor stability to droplet flocculation and coalescence under acidic conditions (pH 3 to 6). In addition, most food proteins form droplets that are cationic (i.e., positively charged) under the conditions found in acidic beverage emulsions, where solution pH is below their isoelectric point. This can cause additional problems to product stability due to an electrostatic attraction between the cationic droplets and various anionic components within the system, e.g., anionic biopolymers, mineral ions, vitamins, flavors, preservatives, buffers, acids, etc. For these reasons, food proteins are rarely used and leave the art in search of another approach to stabilize acidic beverage emulsions.

### SUMMARY OF THE INVENTION

In light of the foregoing, it is an object of the present invention to provide aqueous emulsions and/or related beverage compositions and method(s) for their preparation, thereby overcoming various deficiencies and shortcomings of the prior art, including those outlined above, it will be understood by those skilled in the art that one or more aspects of this invention can meet certain objectives, while one or more other aspects can meet certain other objectives. Each objective may not apply equally, in all its respects, to every aspect of this invention. As such, the following objects can be viewed in the alternative, with respect to any one aspect of this invention.

It is an object of the present invention to provide one or more emulsification systems or compositions demonstrating an appreciable reduction in the total amount of emulsifier required to stabilize the system, as compared to gum arabics of the prior art.

It can be another object to provide stable emulsions under acidic conditions, without significant flocculation or coalescence.

It can be another object of the present invention to provide stable emulsion systems, under acidic conditions, in the presence of one or more charged system components.

It can be an object of the present invention, in conjunction with any one or more of the preceding objectives, to provide an acidic beverage composition comprising one or more of the present emulsions.

Other objects, features, benefits and advantages of the present invention will be apparent from this summary and the following descriptions of certain embodiments, and will be readily apparent to those skilled in art having knowledge of aqueous emulsions, related beverage compositions and products and associated production techniques. Such objects, features, benefits and advantages will be apparent from the above as taken into conjunction with the accompanying examples, data, figures and all reasonable inferences to be drawn there from, alone or with consideration of the references incorporated herein.

In part, this invention can provide a method for preparation and/or stabilizing a beverage comprising an emulsified substantially hydrophobic oil/fat component. Such a method can comprise: providing an oil/fat component; contacting the oil/fat component with an emulsifier component, at least a portion of which has a net charge; and contacting or incorporating therewith one or more food-grade polymeric components, at least a portion of each comprising a net charge opposite that of the emulsifier component and/or a previously incorporated food-grade polymeric component. Without limitation, reference is made to FIG. 1A, a schematic representation for production of an oil/fat emulsion. Such an oil/fat component can be present as part of an acidic beverage composition or product or introduced thereto after emulsion. For instance, an aqueous emulsion of oil droplets surrounded by a multi-layered composition or component membrane can be spray- or freeze-dried to provide a corresponding particulate material then reconstituted as part of a beverage composition. See, e.g., co-pending application entitled “Encapsulated Emulsions and Methods of Preparation,” filed contemporaneously herewith and incorporated herein by reference in its entirety. Regardless, as demonstrated elsewhere herein, such emulsions are pH stable and perform well in the context of an acidic beverage composition.

Accordingly, in certain embodiments, such a method can comprise alternating contact or incorporation of oppositely charged emulsifier and food-grade polymeric components, each such contact or incorporation comprising electrostatic interaction with a previously contacted or incorporated emulsifier or polymeric component. Such methods can optionally comprise mechanical agitation and/or sonication of the resulting compositions to disrupt any aggregation or flocs formed.

In accordance with the preceding, a hydrophobic component can be at least partially insoluble in an aqueous or another medium and/or is capable of forming emulsions in an aqueous medium. In certain embodiments, the hydrophobic component can comprise a fat or an oil component, including but not limited to, any edible food oil known to those skilled in the art (e.g., corn, soybean, canola, rapeseed, olive, peanut, algal, palm, coconut, nut and/or vegetable oils, fish oils or a combination thereof). The hydrophobic component can be selected from hydrogenated or partially hydrogenated fats and/or oils, and can include any dairy or animal fat or oil including, for example, dairy fats. In addition, the hydrophobic component can further comprise flavors, antioxidants, preservatives and/or nutritional components, such as fat soluble vitamins.

It will be readily apparent that, consistent with the broader aspects of the invention, the hydrophobic component can further include any natural and/or synthetic lipid components including, but not limited to, fatty acids (saturated or unsaturated), glycerols, glycerides and their respective derivatives, phospholipids and their respective derivatives, glycolipids, phytosterol and/or sterol esters (e.g., cholesterol esters, phytosterol esters and derivatives thereof), carotenoids, terpenes, antioxidants, colorants, and/or flavor oils (for example, peppermint, citrus, coconut, or vanilla and extracts thereof such as terpenes from citrus oils), as may be required by a given food or beverage end use application. Other such components include, without limitation, brominated vegetable oils, ester gums, sucrose acetate isobutyrate, damar gum and the like. The present invention, therefore, contemplates a wide range of edible oil/fat, waxes and/or lipid components of varying molecular weight and comprising a range of hydrocarbon (aromatic, saturated or unsaturated), alcohol, aldehyde, ketone, acid and/or amine moieties or functional groups.

An emulsifier component can comprise any food-grade surface active ingredient, cationic surfactant, anionic surfactant and/or amphiphilic surfactant known to those skilled in the art capable of at least partly emulsifying the hydrophobic component in an aqueous phase and imparting a net charge to at least a portion thereof. The emulsifier component can include small-molecule surfactants, fatty acids, phospholipids, proteins and polysaccharides, and derivatives thereof. Such emulsifiers can further include one or more of, but not limited to, lecithin, chitosan, modified starches, pectin, gums (e.g., locust bean gum, gum arabic, guar gum, etc.), alginic acids, alginates and derivatives thereof, and cellulose and derivatives thereof. Protein emulsifiers can include any one of the dairy proteins (e.g., whey and casein), vegetable proteins (e.g., soy), meat proteins, fish proteins, plant proteins, egg proteins, ovalbumins, glycoproteins, mucoproteins, phosphoproteins, serum albumins, collagen and combinations thereof. Protein emulsifying components can be selected on the basis of their amino acid residues (e.g., lysine, arginine, asparatic acid, glutamic acid, etc.) to optimize the overall net charge of the interfacial membrane about the hydrophobic component, and therefore the stability of the hydrophobic component within the resultant emulsion system.

Indeed, the emulsifier component can include a broad spectrum of emulsifiers including, for example, acetic acid esters of monogylcerides (ACTEM), lactic acid esters of monogylcerides (LACTEM), citric acid esters of monogylcerides (CITREM), diacetyl acid esters of monogylcerides (DATEM), succinic acid esters of monogylcerides, polyglycerol polyricinoleate, sorbitan esters of fatty acids, propylene glycol esters of fatty acids, sucrose esters of fatty acids, mono and diglycerides, fruit acid esters, stearoyl lactylates, polysorbates, starches, sodium dodecyl sulfate (SDS) and/or combinations thereof.

As discussed above, a polymeric component can comprise any food-grade polymeric material capable of adsorption, electrostatic interaction and/or linkage to the hydrophobic component and/or an associated emulsifier component. Accordingly, the food-grade polymeric component can be a biopolymer material selected from, but not limited to, proteins (e.g., whey, casein, soy, egg, plant, meat and fish proteins), ionic or ionizable polysaccharides such as chitosan and/or chitosan sulfate, cellulose, pectins, alginates, nucleic acids, glycogen, amylose, chitin, polynucleotides, gum arabic, gum acacia, carageenans, xanthan, agar, guar gum, gellan gum, tragacanth gum, karaya gum, locust bean gum, lignin and/or combinations thereof. As mentioned above, such protein components can be selected on the basis of their amino acid residues to optimize overall net charge, interaction with an emulsifier component and/or resultant emulsion stability. The food-grade polymeric component may alternatively be selected from modified polymers such as modified starch, carboxymethyl cellulose, carboxymethyl dextran or lignin sulfonates.

The present invention contemplates any combination of emulsifier and polymeric components leading to the formation of a multi-layered composition comprising an oil/fat and/or lipid component sufficiently stable under environmental or end-use conditions applicable to a particular food product. Accordingly, a hydrophobic component can be encapsulated with and/or immobilized by a wide range of emulsifiers/polymeric components, depending upon the pH, ionic strength, salt concentration, temperature and processing requirements of the emulsion system/food product into which a hydrophobic component is to be incorporated. Such an emulsifier/polymeric component combinations are limited only by electrostatically interaction one with another and formation of a corresponding emulsion. Regardless, upon introduction of a suitable wall component, such an emulsion can be spray-dried or otherwise processed to a powdered or particulate material for storage, transportation and/or subsequent reconstitution in or with a beverage composition. Such hydrophobic components, emulsifier components and polymeric components can be selected from those described or inferred in co-pending application Ser. No. 11/078,216 filed Mar. 11, 2005, the entirety of which is incorporated herein by reference.

In part, this invention can comprise an alternate method for emulsion and particulate formation. With reference to the preceding, a polymeric component can be incorporated with or contact a composition comprising an oil/fat component and an emulsifier component under conditions or at a pH not conducive for sufficient electrostatic interaction therewith. The pH can then be varied to change the net electrical charge of the emulsion, of the emulsified oil/fat component and/or of the polymeric component, sufficient to promote electrostatic interaction with and incorporation of the polymeric component. Without limitation, a stable acidic beverage emulsion can be prepared using a protein emulsifier (e.g., without limitation casein, whey, soy, egg or gelatin) at a pH below its isoelectric point, to form cationic or net positively-charged emulsion droplets, then using an anionic or net negatively-charged polysaccharide (e.g., without limitation, pectin, carrageenan, alginate, or gum arabic) for electrostatic interaction with the initial emulsion composition. (See, e.g., FIG. 1B.) Regardless of method of preparation, such emulsions are stable to interaction with other anionic components, common to an acidic beverage composition.

Regardless of the method of preparation, the emulsion can be contacted with a wall component selected from polar lipids, proteins and/or carbohydrates. Various wall components will be known to those skilled in the art and made aware of this invention. Such emulsions, together with one or more wall components can be used as a feed material from a spray dryer. Accordingly, a corresponding emulsion can be processed into a dispersion of droplets comprising a wall component about emulsified oil/fat components. The dispersion can be introduced to and contacted with a hot drying medium to promote at least partial evaporation of the aqueous phase from the dispersion droplets, providing solid or solid-like particles comprising oil/fat, emulsifier and polymeric compositions within a wall component matrix. Where applicable, the emulsion can be reconstituted in an acidic beverage of the sort described herein.

Without limitation, with reference to the following examples, emulsions can be prepared using food-grade components and standard preparation procedures (e.g., homogenization and mixing). Initially, a primary aqueous emulsion comprising an electrically charged emulsifier component can be prepared by homogenizing an oil/fat component, an aqueous phase and a suitable emulsifier comprising a net charge. Optionally, mechanical agitation or sonication can be applied to such a primary emulsion to disrupt any floc formation, and emulsion washing can be used to remove any non-incorporated emulsifier component. A secondary emulsion can be prepared by contacting a net-charged polymeric component with a primary emulsion. The polymeric component can have a net electrical charge opposite to at least a portion of the primary emulsion. Optionally, mechanical agitation or sonication can also be applied to disrupt any floc formation, and emulsion washing can be used to remove any non-incorporated emulsifier component. As discussed above, emulsion characteristics can be altered by pH adjustment to promote or enhance electrostatic interaction of a primary emulsion and a polymeric component. Regardless of method of preparation, a wall component can be introduced in conjunction or sequentially with either primary or secondary emulsification, for powder formation and subsequent reconstitution with or in a beverage composition.

Accordingly, this invention can also relate, at least in part, to an acidic beverage composition comprising a substantially hydrophobic oil/fat component, an emulsifier component and a polymeric component. Consistent with the broader aspects of this invention, such a composition can comprise a plurality of component layers of any food-grade material about an oil/fat component, each layer comprising a net charge opposite that of at least a portion of an adjacent such material. Alternatively, such an emulsion can be dried then reconstituted as part of a beverage product, such a product including but not limited to any acidic beverage described herein or as would be otherwise known to those skilled in the art. Such beverages, regardless of emulsion reconstitution or formation therein, include but are not limited to medium- and high-acid beverages exhibiting a pH ranging between about 2 and about 6.5, such beverages including but not limited to colas and/or sodas (carbonated and non-carbonated), fruit and vegetable juices and drinks, teas and coffees (and their derivatives), and acidified dairy-based drinks.

### BRIEF DESCRIPTION OF DRAWINGS

FIGS. 1A-B. Illustrating certain non-limiting embodiments, preparation of stabilized beverage emulsions.

FIGS. 2A-B. Dependence of droplet charge (ζ-potential) on polysaccharide concentration in 0.1 wt % corn oil-in-water emulsions containing different kinds of polysaccharide: (A) pH 3; (B) pH 4. The curves on predictions made using Equation 1 and the parameters in Table 1.

FIG. 3. Dependence of the effective ζ-potential of polysaccharide molecules in aqueous solutions on pH.

FIGS. 4A-B. Dependence of the mean particle diameter on polysaccharide concentration in 0.1 wt % corn oil-in-water emulsions containing different kinds of polysaccharide: (A) pH 3; (B) pH 4.

FIGS. 5A-B. Dependence of the turbidity at 800 nm on polysaccharide concentration in 0.1 wt % corn oil-in-water emulsions containing different kinds of polysaccharide: (A) pH 3; (B) pH 4. An increase in turbidity is indicative of particle aggregation.

FIGS. 6A-B. Dependence of the creaming stability on polysaccharide concentration in 0.1 wt % corn oil-in-water emulsions containing different kinds of polysaccharide: (A) pH 3; (B) pH 4. A decrease in creaming stability is indicative of particle aggregation.

FIG. 7. Influence of thermal processing on the stability of 0.1 wt % corn oil-in-water emulsions (pH 4) in the absence and presence of different kinds of polysaccharide.

FIG. 8. Influence of NaCl on the stability of 0.1 wt % corn oil-in-water emulsions (pH 4) in the absence and presence of different kinds of polysaccharide.

FIG. 9. Influence of NaCl on the ζ-potential of 0.1 wt % corn oil-in-water emulsions (pH 4) in the absence and presence of different kinds of polysaccharide.

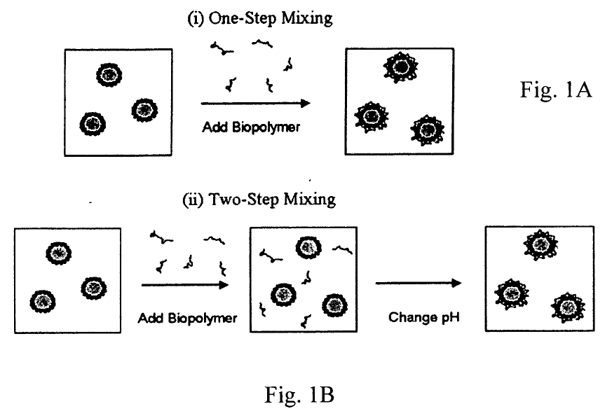

### BRIEF DESCRIPTION OF CERTAIN EMBODIMENTS

As described elsewhere herein, this invention can be directed to acidic, aqueous beverage compositions comprising one or more emulsified oil/fat components, such that the resulting emulsions provide a degree of physical stability, for instance, enhanced over that available using gum arabic emulsifiers of the prior art. The present emulsifier and/or polymeric components can, in certain embodiments, comprise food-grade proteins, as can be processed economically using current production technologies, without further testing or regulatory approval. Further, as described more fully in one or more of the incorporated references, such emulsifiers and polymeric components can also enhance the stability of an emulsified hydrophobic component to degradation (e.g., oxidation).

Without limitation, emulsions stabilized by multi-component interfacial membranes of this invention can be prepared by one of three methods: (1) incorporating emulsifiers and/or polymeric components into a system before homogenization of oil and aqueous phases; (2) incorporating emulsifiers and/or polymeric components into a system after homogenization of oil and aqueous phases; and (3) incorporating emulsifiers and/or polymeric components into a system during homogenization of oil and aqueous phases. As discussed elsewhere herein, the aqueous phase of such a preparatory system can be an acidic beverage composition or component useful en route thereto.

With reference to method (2), for instance, a multiple-stage process could be used to produce an emulsion, coated by two or three component layers (e.g., emulsifier-biopolymer 1-(optionally) biopolymer 2). First, a primary emulsion comprising electrically charged droplets stabilized by a layer of emulsifier can be prepared by homogenizing an oil component, aqueous phase and an ionic or amphiphilic emulsifier together. If necessary, mechanical agitation or sonication can be applied to the primary emulsion to disrupt any flocs formed, and emulsion washing could be carried out to remove any non-adsorbed biopolymer (e.g., by centrifugation or filtration). Second, a secondary emulsion comprising charged droplets stabilized by emulsifier-biopolymer 1 membranes can be formed by incorporating biopolymer 1 into the primary emulsion. Biopolymer 1 can have a net electrical charge opposite that of the net charge of at least a portion of the droplets in the primary emulsion. If necessary, mechanical agitation or sonication can be applied to the secondary emulsion to disrupt any flocs formed, and washing could be used to remove any non-adsorbed biopolymer (e.g., by centrifugation or filtration). Third, tertiary emulsions comprising droplets stabilized by emulsifier-biopolymer 1-biopolymer 2 interfacial membranes can be formed by incorporating biopolymer 2 into the secondary emulsion. Biopolymer 2 can have a net electrical charge opposite the net charge of at least a portion of the droplets in the secondary emulsion. If necessary, mechanical agitation or sonication can be applied to the tertiary emulsion to disrupt any flocs formed, and emulsion washing could be carried out to remove any non-adsorbed biopolymer (e.g., by centrifugation or filtration). This procedure can be continued to add more layers to the interfacial membrane.

For example, with reference to examples 1-3, emulsions containing tri-layer coated lipid droplets were prepared using a method that utilizes food-grade ingredients (lecithin, chitosan, pectin) and standard preparation procedures (homogenization, mixing). Initially, a primary emulsion containing small anionic capsules was produced by homogenization of oil, water and lecithin. A secondary emulsion containing cationic capsules coated with a lecithin-chitosan membrane was then produced by mixing a chitosan solution with the primary emulsion, and applying mechanical agitation to disrupt

any flocs formed. A tertiary emulsion containing anionic capsules coated with a lecithin-chitosan-pectin membrane was then produced by mixing a pectin solution with the secondary emulsion, and again applying mechanical agitation to disrupt any flocs formed.

The secondary and tertiary emulsions had good stability to aggregation over a wide range of pH values, including those common to the acidic beverage compositions of this invention.

As described herein, the emulsion system can be prepared by contacting a fat/oil component with one or more emulsifier and/or polymeric components. The emulsions are stable under end-use conditions, whereby the lipid, emulsifier and/or polymeric components are selected based on the temperature, pH, salt concentration, and ionic strength appropriate for the processing and end-use application of a particular beverage product. Moreover, there exists a wide range of component choice for each layer component encapsulating the lipid component, thereby permitting selection of component materials that do not alter the physicochemical and sensory properties of the encapsulated lipids and permitting such encapsulated lipids to be readily substituted into beverage products without adverse affect on the taste, appearance, texture and stability of the products.

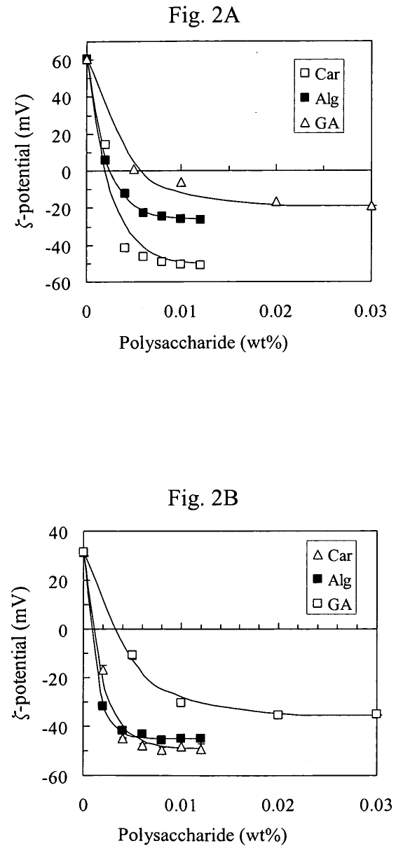

With reference to examples 4a-c and 5a-e, a number of experiments were undertaken to determine whether various polysaccharides would adsorb to the surface of protein-coated oil droplets, and to obtain information about the electrical characteristics of the interfaces formed. Initially, β-Lg-stabilized emulsions were prepared at pH 7 in the absence (primary emulsions) and presence (secondary emulsions) of different types and concentration of polysaccharide. At pH 7, the protein and polysaccharides have similar electrical charges and therefore we would not have expected the polysaccharides to have adsorbed to the surfaces of the protein-coated droplets. We then decreased the pH of the emulsions from pH 7 to either pH 3 or 4 and measured the particle ζ-potential of the resulting emulsions after 1 day storage (FIG. 2). At these pH values, the signs of the electrical charge on the protein (positive) and polysaccharides (negative) are opposite, so that one would expect the anionic polysaccharides in the aqueous phase to be electrically attracted towards the cationic protein-coated droplets.

The electrical charge (ζ-potential) on the emulsion droplets was strongly dependent on final pH, polysaccharide type and polysaccharide concentration (FIG. 2). In the absence of polysaccharide, the electrical charge on the protein-coated emulsion droplets was positive, because the adsorbed β-Lg was below its isoelectric point (pI˜5.0). As the polysaccharide concentration in the aqueous phase of the emulsions was increased, the electrical charge on the droplets initially became less positive then it became more negative, until it finally reached a plateau value (ζ_{Sat}) Similar results have been observed in previous studies, where the change in ζ-potential was attributed to progressive adsorption of anionic polysaccharides onto the surfaces of cationic protein-coated droplets, until the droplet surfaces had become saturated. The steepness of the initial change in ζ-potential with increasing polysaccharide concentration and the saturation ζ-potential depended on polysaccharide type and pH.

The ζ-potential was modeled versus polysaccharide concentration curves in terms of the following empirical equation:

$$\frac{ζ ( c ) - {ζ}_{Sat}}{{ζ}_{0} - {ζ}_{Sat}} = exp ( - \frac{c}{{c}^{*}} ) \qquad ( 1 )$$

Where ζ(c) is the ζ-potential of the emulsion droplets at polysaccharide concentration c, ζ0 is the ζ-potential in the absence of polysaccharide, ζ_{Sat} is the ζ-potential when the droplets are saturated with polysaccharide, and c* is a critical polysaccharide concentration. Mathematically, c* is the polysaccharide concentration where the change in ζ-potential is 1/e of the total change in ζ-potential for saturation: Δζ=Δζ_{Sat}/e. The value of c* is therefore a measure of the binding affinity of the polysaccharide for the droplet surface: the higher c*, the lower the binding affinity. The binding of a polysaccharide to the droplet surface can therefore be characterized by ζSat and c*. Values for ζ₀, ζSat and c* are tabulated in Table 1 for the three different polysaccharides at pH 3 and 4. The values of ζ₀ and ζ_{Sat} were determined from the ζ-potential measurements in the absence of polysaccharide and at the highest polysaccharide concentration used (where saturation was assumed). The c* values were then obtained by finding the quantities that gave the best fit between Equation 1 and the experimental data (using the Solver routine in Excel, Microsoft Corp). There was good agreement between the experimental measurements and the ζ-potential values predicted for the secondary emulsions using Equation 1 and the parameters listed in Table 1 (FIG. 2).

The binding affinity was dependent on polysaccharide type and solution pH (Table 1). At both pH 3 and 4, the c* values were appreciably lower for alginate and carrageenan than for gum arabic, which suggested that they had a stronger binding affinity for the droplet surfaces. For carrageenan and gum arabic the binding affinities were fairly similar at pH 3 and 4, but for alginate the binding affinity was considerably higher (lower c*) at pH 4 than at pH 3. The saturation value of the ζ-potential was also dependent on polysaccharide type and solution pH (Table 1). The protein/carrageenan-coated droplets had the highest negative charge and had similar ζ_{Sat} values at pH 3 and 4 (ζ_{Sat}≈−50 mV). The protein/alginate-coated droplets had a high negative charge at pH 4 (ζ_{Sat}≈−45 mV), but were appreciably less charged at pH 3 (ζ_{Sat}≈−26 mV). The protein/gum arabic-coated droplets had the smallest negative charge at both pH values, but the negative charge was appreciably higher at pH 4 (ζ_{Sat}≈−35 mV) than at pH 3 (δ_{Sat}≈−19 mV).

TABLE 1
Parameters characterizing the binding of polysaccharides to protein-
coated droplet surfaces determined from ζ-potential versus
polysaccharide concentration measurements at pH 3 and 4
using Equation 1.

| | l-Carrageenan | | Sodium Alginate | | Gum Arabic | |
|---|---|---|---|---|---|---|
| Parameter | pH 3 | pH 4 | pH 3 | pH 4 | pH 3 | pH 4 |
| ζ₀ (mV) | 60.6 ± 0.7 | 31.4 ± 0.9 | 60.6 ± 0.7 | 31.4 ± 0.9 | 60.6 ± 0.7 | 31.4 ± 0.9 |
| ζ_{Sat} (mV) | −51.1 ± 1.9 | −49.2 ± 2.0 | −26.2 ± 2.0 | −45.1 ± 2.6 | −19.2 ± 0.4 | −35.4 ± 0.4 |
| Δζ_{Sat} (mV) | 112 ± 2 | 80.6 ± 2.2 | 86.8 ± 2.1 | 76.5 ± 2.8 | 79.8 ± 0.8 | 66.8 ± 1.0 |
| c* (wt %) | 0.0025 | 0.0019 | 0.0021 | 0.0012 | 0.0042 | 0.0046 |

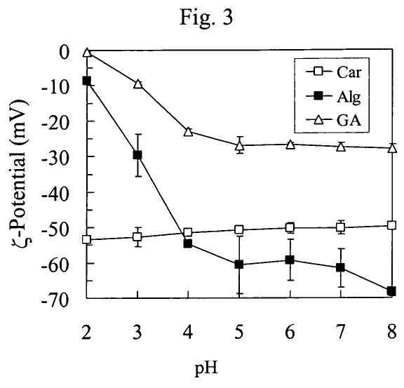

The difference in the electrical characteristics of the protein/polysaccharide-coated droplets was believed due to differences in the electrical charge densities of the polysaccharide molecules. Consequently, the electrical characteristics (ζ-potential versus pH) of 0.1 wt % aqueous polysaccharide solutions was measured (FIG. 3). These measurements show that the ζ-potential of the polysaccharide molecules (ζ_{PS}) follows the same trend as the ζ_{Sat} values of the emulsion droplets coated by protein/polysaccharide complexes: ζ_{PS}=−53, −30 and −9 mV at pH 3 and ζP_{S}=−51, −55 and −23 mV at pH 4 for carrageenan, alginate and gum arabic, respectively (FIG. 3). The electrical charge on the carrageenan molecules and protein/carrageenan-coated droplets is highly negative at both pH 3 and 4. The electrical charge on the alginate molecules and protein/alginate-coated droplets is highly negative at pH 4 but less so at pH 3. The electrical charge on the gum arabic molecules and protein/gum arabic-coated droplets is considerably less negative than for the other two polysaccharides, and is appreciably lower at pH 3 than 4.

Thus, it appears that the electrical characteristics of the protein/polysaccharide-coated droplets are largely determined by the electrical characteristics of the polysaccharide molecules.

It is also insightful to examine the overall change in the ζ-potential when the protein-coated droplets are saturated with polysaccharide: Δζ_{Sat}=ζ₀−ζ₀−ζ_{Sat} (Table 1). For carrageenan, the overall change in ζ-potential is considerably higher at pH 3 (Δζ_{Sat}≈112 mV) than at pH 4 (Δζ≈81 mV), even though the final ζ_{Sat} values are fairly similar at both pH values (ζ_{Sat}≈−50 mV). The electrical charge on the carrageenan molecules was fairly similar at pH 3 and 4 (FIG. 3), hence we can postulate that more carrageenan molecules adsorbed to the droplet surfaces at pH 3 than at pH 4 without limitation. A possible explanation for this observation can be given in terms of the electrical interactions between a charged polysaccharide and a charged surface that it is approaching. Studies of the adsorption of synthetic polyelectrolytes onto oppositely charge surfaces have reported that the final ζ-potential is largely independent of the charge density of the adsorbing polyelectrolyte, provided that its charge density is not too low. This phenomenon was attributed to the fact that once the surface charge has reached a certain value there will be a strong electrostatic repulsion between the surface and similarly charged polyelectrolytes in the aqueous phase, which limits further adsorption of the polyelectrolyte. Hence, we postulate that the carrageenan molecules adsorbed to the protein-coated droplet surfaces until a certain ζ-potential was reached (≈−50 mV) and then the electrostatic repulsion was strong enough to prevent further polymer adsorption.

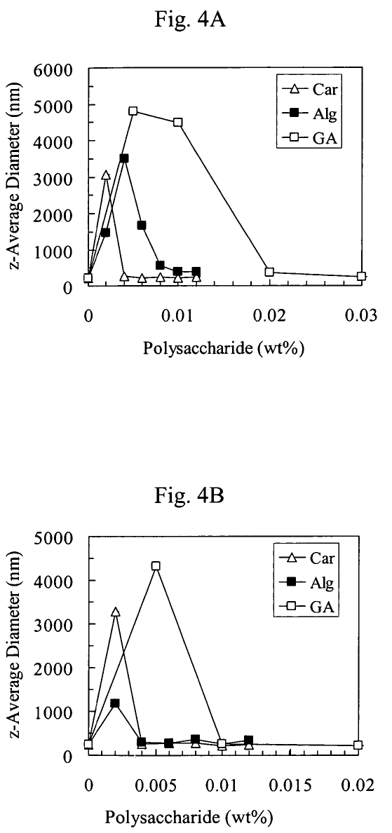

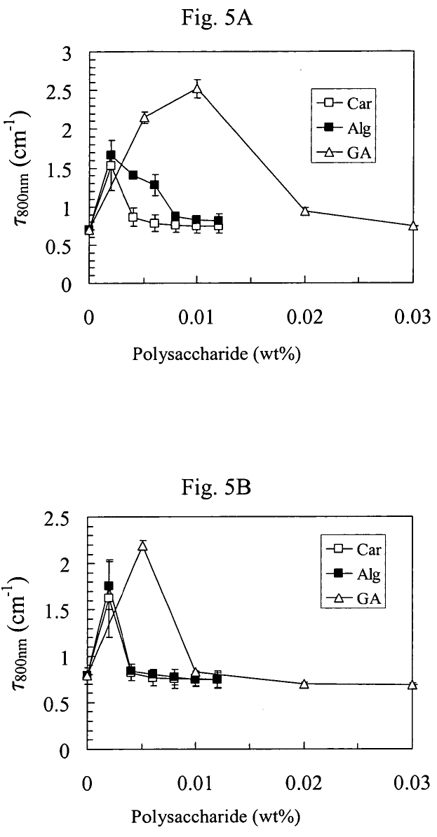

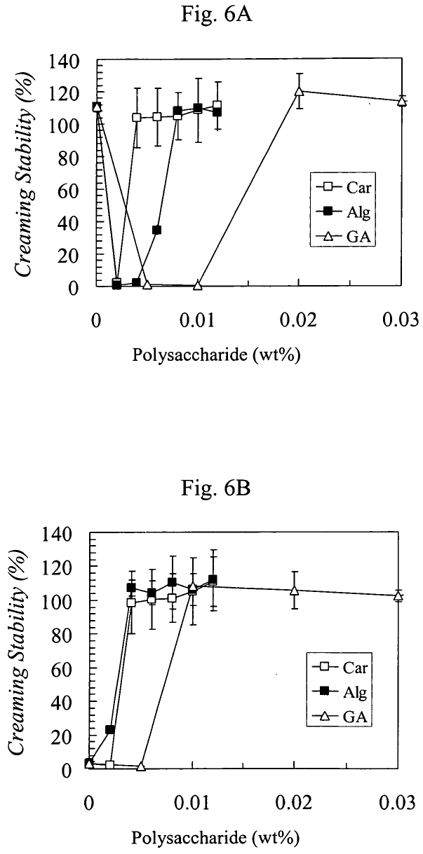

The purpose of these experiments was to examine the influence of polysaccharide type, polysaccharide concentration and pH on the stability of oil-in-water emulsions containing β-Lg-coated droplets. As explained above, β-Lg-stabilized emulsions were prepared at pH 7 in the absence (primary emulsions) and presence (secondary emulsions) of different types and concentration of polysaccharide, and then the pH was reduced to either 3 or 4 by adding acid. The stability of the emulsions to droplet aggregation and creaming was then determined using light scattering, turbidity and creaming stability measurements (FIGS. 4 to 6).

The stability of the emulsions to droplet aggregation and creaming was highly dependent on polysaccharide type, polysaccharide concentration and solution pH (FIGS. 4 to 6). In the absence of polysaccharide, the primary emulsions appeared stable to droplet aggregation (low z-diameter, low τ800) after 24 hours storage at pH 3 and 4. Presumably, the positive charge on the protein-coated droplets was sufficiently high to prevent droplet aggregation by generating a strong inter-droplet electrostatic repulsion (3). The primary emulsion at pH 3 was also stable to creaming after 7 days storage at room temperature, which indicated that droplet aggregation did not occur. On the other hand, the primary emulsion at pH 4 was unstable to creaming after 7 days storage, which indicated that some droplet aggregation had occurred over time. The reason that the primary emulsion was unstable to creaming at pH 4 may have been because this pH is fairly close to the isoelectric point of the adsorbed β-lactoglobulin molecules, so that there may not have been a sufficiently strong electrostatic repulsion between the droplets to prevent aggregation during long-term storage.

At intermediate polysaccharide concentrations, the secondary emulsions were highly unstable to droplet aggregation (high z-diameter, high τ800) and creaming. This phenomenon can be attributed to charge neutralization and bridging flocculation affects. When there is insufficient polysaccharide present to completely cover the protein-coated droplets there will be regions of positive charge and regions of negative charge exposed at the droplets surfaces, which will promote bridging flocculation. In addition, the overall net charge on the droplets was relatively small (|ζ|<15 mV), so that the electrostatic repulsion between the droplets would have been insufficient to overcome the attractive interactions (e.g., van der Waals and hydrophobic). At high polysaccharide concentrations, the secondary emulsions were stable to droplet aggregation (low z-diameter, low τ800) and creaming at both pH 3 and 4. This re-stabilization can be attributed to the fact that the droplet surfaces were completely covered with polysaccharide and the droplet charge was relatively high (FIG. 2). In addition, the interfacial thickness will have increased due to the adsorption of the polysaccharide to the droplet surfaces. Hence, there would be a strong electrostatic and steric repulsion between the protein/polysaccharide-coated droplets that should oppose their aggregation.

The range of intermediate polysaccharide concentrations where the emulsions were unstable to droplet aggregation and creaming depended on polysaccharide type and pH (FIGS. 4 to 6). For example, emulsions containing protein-coated droplets to which carrageenan was added were only unstable at 0.002 wt % at pH 3 and 4; those where alginate was added were unstable at 0.002 wt % at pH 4 but from 0.002 to 0.006 at pH 3; and, those where gum arabic was added were unstable from 0.002 to 0.006 wt % at pH 4 but from 0.002 to 0.01 wt % at pH 3. These differences in droplet aggregation behavior can be attributed to the differences in droplet charge (FIG. 2). In general, the emulsions were stable to droplet aggregation provided the magnitude of the ζ-potential was high and the droplets were sufficiently covered with polysaccharide.

Stability of emulsions to environmental stresses. The purpose of this series of experiments was to determine whether the secondary emulsions containing protein/polysaccharide-coated droplets had better stability to environmental stresses than the primary emulsions containing protein-coated droplets. ζ-potential measurements were used to assess the interaction of the polysaccharides with the protein-coated droplets and creaming stability measurements were used to assess the overall stability of the emulsions. Primary and secondary emulsions (0.1 wt % corn oil-in-water emulsions, pH 4) with different salt concentrations (0, 50 or 100 mM NaCl), sugar concentrations (0 or 10 wt % sucrose) and heat treatments (30 or 90° C.) were analyzed. The polysaccharide concentration in the secondary emulsions was selected so that: (i) it was sufficient to saturate the protein-coated droplet surfaces as determined from ζ-potential measurements (FIG. 2); (ii) it was just above the minimum amount needed to produce secondary emulsions that were stable to droplet aggregation and creaming (FIGS. 4 to 6). For this reason, the secondary emulsions were prepared using 0.004 wt % carrageenan, 0.004 wt % alginate or 0.02 wt % gum arabic.

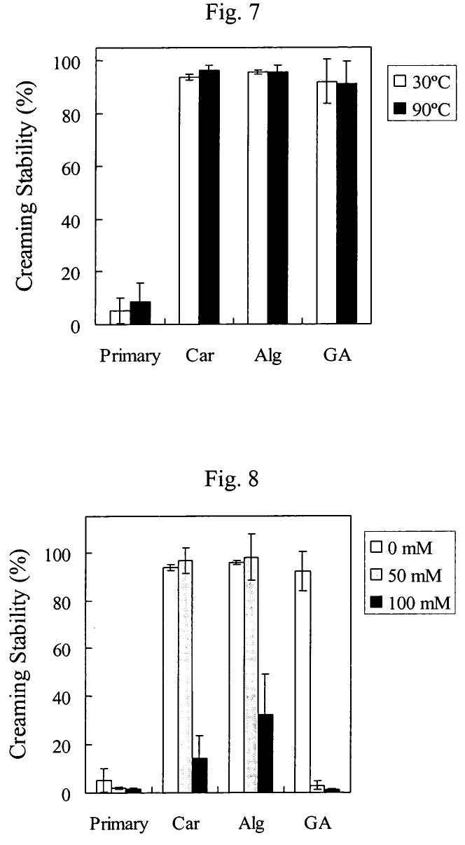

The influence of thermal processing (30 or 90° C. for 30 minutes) on the stability of the emulsions is shown in FIG. 7. Previous studies have shown that heating β-Lg stabilized emulsions to 90° C. can promote droplet flocculation due to thermal denaturation of the adsorbed proteins. The unheated and heated primary emulsions were both unstable to heating because the pH was fairly close to the isoelectric point of the adsorbed β-lactoglobulin so that there was not a sufficiently strong electrostatic repulsion between the droplets to prevent aggregation. On the other hand, all of the secondary emulsions were stable to heat treatment (FIG. 7). The polysaccharides are believed to have adsorbed to the surfaces of the protein-coated droplets and increased the steric and electrostatic repulsion between the droplets by increasing the thickness and charge of the interfaces. Results suggest that heating did not cause the polysaccharides to be desorbed from the droplet surfaces otherwise the secondary emulsions would have become unstable to droplet aggregation like the primary emulsions. This hypothesis was confirmed by the ζ-potential measurements, which showed that the electrical charge on the droplets in the secondary emulsions changed by less than ±2 mV upon thermal processing (data not shown). Hence, there was no evidence of desorption of the polysaccharides from the droplet surfaces induced by heating.

The influence of salt addition (0, 50 or 100 mM NaCl) on the stability of the emulsions is shown in FIG. 8. The primary emulsion was unstable at all salt concentrations for the reasons mentioned above. The secondary emulsions containing alginate and carrageenan were stable to creaming at 0 and 50 mM NaCl, but were unstable at 100 mM NaCl. On the other hand, the secondary emulsions containing gum arabic were highly unstable to creaming at 50 and 100 mM NaCl. The addition of salt to the emulsions may have adversely affected their creaming stability in a number of ways. First, salt screens the electrostatic repulsion between charged droplets, which can promote droplet aggregation when the strength of the repulsive colloidal interactions is no longer strong enough to overcome the attractive colloidal interactions. Second, the presence of salt in the emulsions may have weakened the electrostatic attraction between the polysaccharides and the protein-coated oil droplets, which may have led to partial or full desorption of the polysaccharide molecules. The fact that the ζ-potential of these emulsions did not change appreciably with increasing salt concentration (see below), suggests that the carrageenan molecules were not fully desorbed from the droplet surfaces. Nevertheless, weakening of the attraction between the polysaccharides and the protein-coated droplet surfaces may have led to bridging flocculation due to adsorption of a polysaccharide onto more than one droplet. At pH 4, the protein/gum arabic-coated droplets have an appreciably lower ζ-potential than the protein/carrageenan- or protein/alginate-coated droplets, which means that the electrostatic repulsion between the droplets is weaker. This would account for the fact that a lower amount of NaCl was needed to promote droplet aggregation in the gum arabic emulsions. In addition, the binding affinity of the gum arabic for the droplet surfaces was less than that of the carrageenan and alginate (Table 1), so it is also possible that the NaCl may have desorbed the gum arabic more easily. Measurements of the droplet ζ-potential were used to provide further insight into the physicochemical origin of the observed changes in emulsion stability with salt addition.

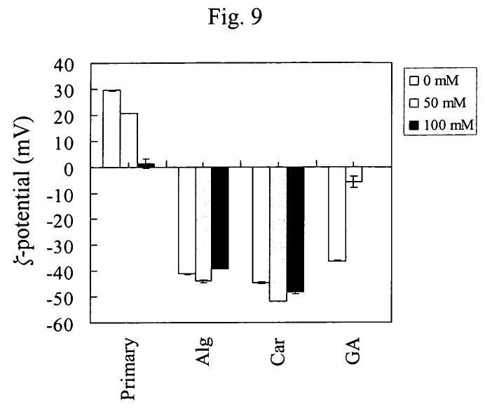

The influence of NaCl on the ζ-potential measurements was highly dependent on the polysaccharide type used to prepare the secondary emulsions (FIG. 9). Normally, one would expect a progressive decrease in ζ-potential with increasing salt concentration due to electrostatic screening affects, since ζ∝κ⁻¹ (assuming constant surface charge density and no change in interfacial structure), where κ⁻¹ is the Debye screening length (3). For aqueous solutions at room temperature, the Debye screening length is related to the ionic strength through: κ⁻¹=0.304/√I nm, where I is the ionic strength of the solution expressed in moles per liter (3). Hence, one would expect that the droplet potential should decrease with increasing salt concentration in the following manner: ζ∝1/√I.

For the protein-coated droplets there was a progressive decrease in ζ-potential with increasing salt concentration (FIG. 9), which can be attributed to electrostatic screening effects. On the other hand, for the protein/carrageenan- and protein/alginate-coated droplets the reduction in ζ-potential with increasing salt concentration was much less than expected. This type of behavior has also been observed for secondary emulsions containing β-lactoglobulin/pectin-coated droplets, where it was attributed to a change in the composition, thickness or structure of the interfacial membrane with salt concentration. Changes in these interfacial properties as a result of salt addition may arise due to a reduction in the electrostatic interactions between adsorbed and non-adsorbed polysaccharides (repulsive), between two or more adsorbed polysaccharides (repulsive), or between adsorbed polysaccharides and proteins (attractive). Finally, the protein/gum arabic-coated droplets showed a much larger decrease in ζ-potential with increasing salt concentration than the protein/alginate- or protein/carrageenan-coated droplets, which suggested that some of the gum arabic may have desorbed from the droplet surfaces, thereby promoting instability at a lower NaCl concentration through charge neutralization and polymer bridging effects. The different behavior of the three polysaccharides may have been because of their different chemical composition (functional groups) or their different molecular conformations. Carrageenan and alginate molecules would be expected to be more extended in structure than gum arabic molecules.

The influence of sugar addition (0 or 10 wt % sucrose) on the stability of the emulsions was also determined (data not shown). No change in droplet ζ-potential or creaming stability was observed in the absence or presence of sucrose, which indicated that sucrose had no affect on interfacial composition or emulsion stability.

As illustrated below, representative of the broader aspects of this invention, beverage emulsions can be produced that contain oil droplets coated by protein/polysaccharide interfaces. These interfacial complexes were formed by electrostatic deposition of anionic polysaccharides onto cationic protein-coated droplets. The electrical characteristics of the interfaces formed appeared to be mainly determined by the electrical charge of the polysaccharides, which was governed by solution pH and polysaccharide type. The secondary emulsions formed were stable to thermal processing (90° C. for 30 minutes), sugar (10% sucrose) and salt (≦50 mM NaCl). These results show that this interfacial engineering technology can be used by the beverage industry to replace traditional polysaccharide emulsifiers such as gum arabic and modified starch. Advantages of the protein/polysaccharide complexes over traditional polysaccharide emulsifiers include that they can be used at much lower levels, and that there may be less variation in price and quality in protein than in polysaccharide emulsifiers.

### EXAMPLES OF THE INVENTION

The following non-limiting examples and data illustrate various aspects and features relating to the emulsions/beverages and/or methods of the present invention, including the preparation of acidic beverage emulsions, as are available through the methodologies described herein. In comparison with the prior art, the present emulsions/beverage systems and methods provide results and data which are surprising, unexpected and contrary thereto. While the utility of this invention is illustrated through the use of several aqueous beverage-like systems and emulsifier/polymeric component combinations used therewith, it will be understood by those skilled in the art that comparable results are obtainable with various other such systems, acidic beverage compositions hydrophobic components and emulsifier/polymeric component combinations, as are commensurate with the scope of this invention.

### Example 1a

A tertiary emulsion was prepared with a composition of 0.5 wt % corn oil, 0.1 wt % lecithin, 0.0078 wt % chitosan, 0.02 wt % pectin, and 100 mM acetic acid (pH 3.0). Prior to utilization, any flocs formed in this emulsion were disrupted by passing it twice through a high pressure value homogenizer at 4000 psi. A series of dilute emulsions (˜0.005 wt % corn oil) with different pH (3 to 8) and ionic strength (0 or 100 mM NaCl) were formed by diluting primary, secondary and tertiary emulsions with distilled water or NaCl solutions and then adjusting the pH with HCl or NaOH. These emulsions could be analyzed directly by laser diffraction, particle electrophoresis and turbidity techniques without the need of further dilution. The diluted primary, secondary and tertiary emulsions were then stored for 1 week at room temperature and their electrical charge and mean droplet diameter were measured.

### Example 1b

Affect on Droplet Charge—Primary Emulsions. The ζ-potential of the droplets in the primary emulsions was negative at all pH values, but was appreciably more negative at high than at low pH (FIG. 4). The droplet charge was probably less negative at low pH because a smaller fraction of the adsorbed lecithin molecules were ionized, since the pKₐ value of the anionic phosphate groups on lecithin is around pH 1.5. The magnitude of the electrical charge on the droplets in the primary emulsions decreased upon the addition of salt, e.g., the ζ-potential changed from −42 to −13 mV at pH 3 when the NaCl was increased from 0 to 100 mM. This reduction can be attributed to electrostatic screening effects, which cause a reduction in the surface charge potential of colloidal particles with increasing ionic strength.

### Example 1c

Affect on Droplet Charge—Secondary Emulsions. The ζ-potential of the secondary emulsions was highly positive (˜38 mV) at pH 3 due to adsorption of cationic chitosan molecules onto the surface of the anionic lecithin-coated droplets. As the pH was increased the electrical charge on the droplets became less positive (pH 4), and eventually it became negative (pH≧5). The reduction in the positive charge on the droplets with increasing pH is probably the result of deprotonation of the —NH₃⁺ groups on the chitosan. These groups have a pK value around 6.3 to 7, hence as the pH is increased the chitosan becomes less positively charged. As the chitosan loses its positive charge, the electrostatic attraction between the anionic lecithin molecules and the cationic chitosan molecules decreases. Consequently, it is possible that the chitosan molecules may have desorbed from the droplet surfaces at higher pH, although this is not necessary to explain the observed effects.

### Example 1d

Affect on Droplet Charge—Tertiary Emulsions. At pH 3, the ζ-potential in the tertiary emulsions was slightly positive (+8 mV) in the absence of salt, which suggests that the negative charge on the adsorbed pectin molecules was insufficient to overcome the high positive charge on the lecithin-chitosan coated droplets (+38 mV). The pKₐ value of the carboxylic groups on pectin is usually around pH 4 to 5, hence pectin has a smaller negative charge at low pH than at high pH. Consequently, its effectiveness at decreasing the positive charge on the lecithin- chitosan coated droplets would have been reduced at this low pH. Interestingly, when 100 mM NaCl was present at pH 3, the charge on the tertiary emulsions was negative (−9 mV), which suggests that the negative charge on the adsorbed pectin was sufficient to overcome the much reduced positive charge (+11 mV) on the lecithin-chitosan coated droplets in the presence of salt. At pH≧4, the tertiary emulsions were anionic in the presence and absence of salt, which suggested that the negative charge on the adsorbed pectin molecules was more than sufficient to balance the positive charge on the lecithin-chitosan coated droplets.

### Example 2a

Affect on Droplet Aggregation—Primary Emulsions. The droplets in the primary emulsions were relatively stable to extensive droplet aggregation at all pH and NaCl values. Nevertheless, the particles in the emulsions stored at low pH values (pH 3 and 4) in the presence of salt were significantly larger than those in the emulsions stored in the absence of salt. For example, at pH 3, d₃₂=2.1±0.2 μm at 100 mM NaCl and 0.91±0.09 μm at 0 mM NaCl. Droplet aggregation at low pH and high salt may have been because the reduced charge on the lecithin molecules combined with the increased electrostatic screening caused a reduction in the electrostatic repulsion between the droplets. In addition, salt reduces the curvature of phospholipid membranes by reducing the effective head group size of the polar lipids, which favors droplet coalescence in emulsions.

### Example 2b

Affect on Droplet Aggregation—Secondary Emulsions. In the absence of added NaCl, the droplets in the secondary emulsions were relatively stable to droplet aggregation at low (pH 3 and 4) pH values, but were highly unstable at intermediate pH (between 5 to 7) values. The droplets were probably stable to droplet aggregation at pH 3 because the high positive charge on the droplets led to strong electrostatic repulsion between the droplets. As the pH was increased the chitosan molecules began to lose their positive charge (pKₐ˜6.3 to 7), and hence the charge on the droplets decreased. In addition, the chitosan molecules would be less strongly held to the surface of the lecithin coated droplets because the electrostatic attraction between cationic chitosan and the anionic lecithin molecules would be reduced. Consequently, some of the chitosan molecules may have been completely or partly displaced from the surface of the emulsion droplets.

These chitosan molecules could then act as polymeric bridges that held the negatively charged lecithin coated droplets together. Bridging flocculation may therefore have been responsible for the high degree of droplet aggregation observed at intermediate (5 to 7) pH values. In the presence of 100 mM NaCl, the emulsions were still relatively stable to flocculation at low pH values (pH 3 and 4), but were unstable at all higher values.

### Example 2c

Affect on Droplet Aggregation—Tertiary Emulsions. The droplets in the tertiary emulsions were stable to droplet aggregation at all pH values in the absence and presence of salt, with the exception of the pH 3 emulsion at 0 mM NaCl. Aggregation probably occurred in this emulsion because the droplets had a small ζ-potential so that the electrostatic repulsion between them was relatively weak. In addition, there may have been bridging flocculation between the negatively charged pectin molecules in the aqueous phase and the positively charged droplets. These results indicate that emulsions with good stability against droplet aggregation can be produced using lecithin-chitosan-pectin membranes.

### Example 3a

Illustrating various other aspects of this invention, tuna oil-in-water emulsions were prepared containing 5 wt % tuna oil, 1 wt % lecithin and 0.2 wt % chitosan. A concentrated tuna oil-in-water emulsion (15 wt % oil, 3 wt % lecithin) was made by blending 15 wt % tuna oil with 85 wt % aqueous emulsifier solution (3.53 wt % lecithin) using a high-speed blender (M133/1281-0, Biospec Products, Inc., ESGC, Switzerland), followed by three passes at 5,000 psi through a single-stage high pressure valve homogenizer (APV-Gaulin, Model Mini-Lab 8.30H, Wilmington, Mass.). This primary emulsion was diluted with aqueous chitosan solution to form a secondary emulsion (5 wt % tuna oil, 1 wt % lecithin and 0.2 wt % chitosan). Any flocs formed in the secondary emulsion were disrupted by passing it once through a high-pressure valve homogenizer at a pressure of 4,000 psi. As discussed in the aforementioned contemporaneous application, secondary emulsions can also be prepared by mixing with corn syrup solids (20 wt %) in solution. Powder was prepared via spray-drying, as also described therein.

### Example 3b

The powder (0.5 g) was dissolved in 4.5 mL acetate buffer at the desired pH (from 3 to 8). The reconstituted emulsions were transferred into glass test tubes (internal diameter=15 mm, height=125 mm), which were then stored at room temperature prior to analysis. The electrical charge (4-potential) of oil droplets in the emulsions was determined using a particle electrophoresis instrument (ZEM5003, Zetamaster, Malvern Instruments, Worcs., UK). The emulsions were diluted to a droplet concentration of approximately 0.008 wt % with pH-adjusted double-distilled water prior to analysis to avoid multiple scattering effects.

### Example 3c

A series of dilute emulsions (10 g solid/100 g emulsion), with different pH values (3 to 8), were stored at room temperature for 24 h and electrical charge (ζ-potential) was measured.

The ζ-potential of the reconstituted emulsions was positive at low pH values (<pH 8) but became negative at higher values. The cationic groups on chitosan typically have pKₐ values around 6.3-7. See, Schulz, P. C., Rodriguez, M. S., Del Blanco, L. F., Pistonesi, M., & Agullo, E. (1998). Emulsification properties of chitosan. Colloid and Polymer Science, 276, 1159-1165. Hence, the chitosan begins to lose some of its charge around this pH. Consequently, there may have been a weakening in the electrostatic attraction between the chitosan and the lecithin-coated droplets, which may have led to the release of some of the adsorbed chitosan. Alternatively, some or all of the chitosan may have remained adsorbed to the droplet surfaces, but the droplets became negatively charged because the chitosan lost some of its positive charge. The reconstituted emulsions were stable to droplet aggregation at pH<5.0, but highly unstable at higher pH values, as deduced from the large increase in mean particle diameter. The instability of the emulsions at higher pH values was probably because the magnitude of the ζ-potential was relatively low, which reduced the electrostatic repulsion between the droplets, leading to extensive droplet flocculation. In addition, partial desorption of chitosan molecules from the droplet surfaces may have led to some bridging flocculation.

Materials and Methods.

Materials for Examples 4-5.

Powdered β-lactoglobulin (β-Lg) was kindly supplied by Davisco Foods International (lot no. JE 001-3-922, Le Sueur, Minn.). The protein content was reported to be 98.3% (dry basis) by the supplier, with β-Lg making up 95.5% of the total protein. The moisture content of the protein powder was reported to be 4.9%. The fat, ash and lactose contents of this product are reported to be 0.3±0.1, 2.5±0.2 and <0.5 wt %, respectively. Sodium alginate (lot no. 6724, TIC Pretested® Colloid 488T) and gum arabic (lot no. 8475) (food grade) were donated by TIC gums. Food grade t-carrageenan was donated by FMC BioPolymer (Philadelphia, Pa.) (lot no. 10325050). The manufacturers reported that this sample was in almost pure sodium form with a low amount of contamination from other minerals (<5%). Analytical grade hydrochloric acid, sodium hydroxide, sodium azide, and sodium phosphate were obtained from Sigma-Aldrich (St. Louis, Mo.). Corn oil was purchased from a local supermarket and used without further purification. Distilled and deionized water from a water purification system (Nanopure Infinity, Barnstead International, Iowa) was used for the preparation of all solutions.

### Example 4a

Solution Preparation. An emulsifier solution was prepared by dispersing 0.1 wt % β-Lg in 5 mM phosphate buffer (pH 7.0) and stirring for at least 2 h. Sodium alginate, gum arabic and ι-carrageenan solutions were prepared by dispersing the appropriate amount of powdered polysaccharide into 5 mM phosphate buffer (pH 7.0) and stirring for at least 2 h. In the case of ι-carrageenan, the solution was then heated in a water bath at 70° C. for 20 min to facilitate dispersion and dissolution (19). Sodium azide (0.02 wt %) was added to each of the solutions to prevent microbial growth. After preparation, protein and polysaccharide solutions were stored overnight at 5° C. to allow complete hydration of the biopolymers.

### Example 4b

Emulsion Preparation. In this study, the term “primary emulsion” is used to refer to the emulsion created using only the protein as the emulsifier, while the term “secondary emulsion” is used to refer to the primary emulsion to which a polysaccharide has also been added. It should be noted, that the polysaccharide may or may not be adsorbed to the droplet surfaces in the secondary emulsions depending on solution conditions (e.g., pH and ionic strength).

A corn oil-in-water emulsion was prepared by blending 1 wt % corn oil and 99 wt % aqueous emulsifier solution (0.091 wt % β-Lg in 5 mM phosphate buffer, pH 7) for 2 min at room temperature using a high-speed blender (M133/1281-0, Biospec Products, Inc., Switzerland). This coarse emulsion was then passed through a two-stage high-pressure homogenizer (LAB 1000, APV-Gaulin, Wilmington, Mass.) three times to reduce the mean particle diameter: 4500 psi at the first stage and 500 psi at the second stage. The resulting emulsion was then diluted with phosphate buffer and sodium azide solution to obtain a dilute emulsion (0.2 wt % oil, 0.018 wt % β-Lg, pH 7.0). Finally, this dilute emulsion was diluted with different ratios of polysaccharide stock solutions (sodium alginate, ι-carrageenan, or gum arabic) and phosphate buffer solution to yield primary and secondary emulsions with the following compositions: 0.1 wt % corn oil, 0.009 wt % β-Lg, 0 to 0.012 wt % sodium alginate, or 0 to 0.012 wt % ι-carrageenan, or 0 to 0.05 wt % gum arabic (pH 7.0, 5 mM phosphate buffer). The primary and secondary emulsions were then stirred at room temperature for 30 min, and adjusted to either pH 3 or 4 by adding 0.1 or 1 M HCl. Emulsions were then stored at room temperature before being analyzed (see below).

### Example 5a

Particle Charge Measurements. The electrical charge of polysaccharide molecules in aqueous solutions was determined using a commercial instrument capable of electrophoresis measurements (Zetasizer Nano-ZS, Malvern Instruments, Worcestershire, UK). The electrical charge of the droplets in oil-in-water emulsions was determined using another commercial electrophoresis instrument (ZEM, Zetamaster, Malvern Instruments, Worcestershire, UK). These instruments measure the direction and velocity of molecular or particle movement in an applied electric field, and then converts the calculated electrophoretic mobility into a ζ-potential value. The aqueous solutions and emulsions were prepared and stored at room temperature for 24 h prior to analysis.

### Example 5b

Particle Size Measurements. The mean particle size of the emulsions was determined using a commercial dynamic light scattering instrument (Zetasizer Nano-ZS, Malvern Instruments, Worcestershire, UK). This instrument infers the size of the particles from measurements of their diffusion coefficients. The emulsions were prepared and stored at room temperature for 24 h prior to analysis.

### Example 5c

Spectro-Turbidity Measurements. An indication of droplet aggregation in the emulsions was obtained from measurements of the turbidity versus wavelength since the turbidity spectrum of a colloidal dispersion depends on the size of the particles it contains (23). Approximately 1.5 g samples of emulsion were transferred into 5-mm path length plastic spectrophotometer cuvettes. The emulsions were inverted a number of times prior to measurements to ensure that they were homogeneous so as to avoid any changes in turbidity due to droplet creaming. The change in absorbance of the emulsions was recorded when the wavelength changed from 800 nm to 400 nm using a UV-visible spectrophotometer (UV-2101PC, Shimadzu Corporation, Tokyo, Japan), using distilled water as a reference. We found that there was an appreciable increase in emulsion turbidity at 800 nm in those emulsions where droplet aggregation occurred. We therefore used turbidity measurements at this wavelength to provide an indication of the degree of droplet aggregation in the emulsions. The emulsions were prepared and stored at room temperature for 24 h prior to analysis.

### Example 5d

Creaming Stability Measurements. Approximately 3.5 g samples of emulsion were transferred into 10-mm path length plastic spectrophotometer cuvettes and then stored at 30° C. for 7 days. The change in turbidity (τ) at 600 nm of undisturbed emulsions was measured during storage using a UV-visible spectrophotometer (UV-2101 PC, Shimadzu Corporation, Tokyo, Japan) with distilled water being used as a reference. The light beam passed through the emulsions at a height that was about 15 mm from the bottom of the cuvette, i.e., about 42% of the emulsion's height. The oil droplets in the emulsions tended to move upward with time due to gravity, which led to the formation of a relatively clear droplet-depleted serum layer at the bottom of the cuvette. The rate at which this serum layer moved upwards provided an indication of the creaming stability of the emulsions: the faster the rate, the more unstable the emulsions (24). An appreciable decrease in emulsion turbidity was therefore an indication of the fact that the serum layer had risen to at least 42% of the emulsion's height. The creaming stability was quantified in terms of the following expression: Creaming Stability (%)=100×τ(7 days)/τ(0 days), where τ(7 days) and τ(0 days) are the turbidity measurements made at day 0 and day 7, respectively. A value of 100% therefore indicates no evidence of droplet creaming during 7 days storage, whereas a value of 0% indicates that there was rapid creaming (i.e., all the droplets have moved above the measurement point). It should also be noted that the turbidity of an emulsion depends on particle size as well as droplet concentration, so an observed change in Creaming Stability may also reflect changes in droplet aggregation as well as creaming.

### Example 5e

Statistical Analysis. Each of the measurements described above was carried out using at least two freshly prepared samples, and the results are reported as the mean and standard deviation.

We claim:

1. A method of preparing a beverage composition, said method comprising:
providing an aqueous beverage medium comprising a hydrophobic component, said medium at a pH from about 2 to about 6.5;
contacting said hydrophobic component and an emulsifier component, wherein at least a portion of said emulsifier component has a net charge; and
contacting said emulsion and a polymeric component, wherein at least a portion of said polymeric component has a net charge opposite said emulsifier net charge.

2. The method of claim 1, wherein said polymeric component is incorporated with said emulsified hydrophobic component.

3. The method of claim 1, wherein said hydrophobic component is a fat or an oil component selected from corn oil, soybean oil, sunflower oil, canola oil, rapeseed oil, olive oil, peanut oil, algal oil, nut oils, plant oils, vegetable oils, fish oils, flavor oils, animal fats, vegetable fats and combinations thereof.

4. The method of claim 1, wherein said emulsifier component is selected from licithin, chitosan, pectin, locust bean gum, gum arabic, guar gum, alginic acids, alginates, cellulose, modified cellulose, modified starch, whey proteins, caseins, soy proteins, fish proteins, meat proteins, plant proteins, polysorbates, fatty acid salts, small molecule surfactants and combinations thereof.

5. The method of claim 1, wherein said polymeric component is selected from proteins, polysaccharides and combinations thereof.

6. The method of claim 1 where at least one component net charge is provided by adjusting medium pH.

7. The method of claim 6, wherein said emulsifier component comprises a protein and said medium pH is lowered below the isoelectric point of said protein.

8. The method of claim 1, wherein said polymeric component is contacted with another emulsifier component, wherein at a least a portion of said other emulsifier component has a net charge opposite said polymeric component net charge.

9. A method of preparing a beverage emulsion, said method comprising:
providing an aqueous, acidic beverage medium;
providing an aqueous emulsion of a hydrophobic component in said beverage medium, said emulsion comprising an emulsifier component having a net charge; and
contacting said emulsion with a polymeric component, wherein at least a portion of said polymeric component has a net charge opposite said emulsifier component net charge.

10. The method of claim 9, wherein said emulsion is prepared in said beverage medium.

11. The method of claim 9, wherein said emulsion is introduced to said beverage medium.

12. The method of claim 11, wherein said emulsion is introduced as an at least partially dehydrated emulsion of said hydrophobic component.

13. The method of claim 9, wherein said hydrophobic component is a fat or an oil component selected from corn oil, soybean oil, sunflower oil, canola oil, rapeseed oil, olive oil, peanut oil, algal oil, nut oils, plant oils, vegetable oils, fish oils, flavor oils, animal fats, vegetable fats and combinations thereof.

14. The method of claim 9, wherein said emulsifier component is selected from licithin, chitosan, pectin, locust bean gum, gum arabic, guar gum, alginic acids, alginates, cellulose, modified cellulose, modified starch, whey proteins, caseins, soy proteins, fish proteins, meat proteins, plant proteins, polysorbates, fatty acid salts, small molecule surfactants and combinations thereof.

15. An acidic beverage emulsion, comprising:
an emulsion of a hydrophobic component in an aqueous medium, said emulsion comprising an emulsifier component having a net charge; and
a polymeric component, wherein at least a portion of said polymeric component has a net charge opposite that of the emulsifier component net charge, said emulsion having a pH from about 2 to about 6.5.

16. The beverage emulsion of claim 15, wherein the hydrophobic component is a fat or an oil component selected from corn oil, soybean oil, sunflower oil, canola oil, rapeseed oil, olive oil, peanut oil, algal oil, nut oils, plant oils, vegetable oils, fish oils, flavor oils, animal fats, vegetable fats and combinations thereof.

17. The beverage emulsion of claim 15, wherein said emulsifier component is selected from licithin, chitosan, pectin, locust bean gum, gum arabic, guar gum, alginic acids, alginates, cellulose, modified cellulose, modified starch, whey proteins, caseins, soy proteins, fish proteins, meat proteins, plant proteins, polysorbates, fatty acid salts, small molecule surfactants and combinations thereof.

18. The beverage emulsion of claim 15, wherein said polymeric component is selected from proteins, polysaccharides and combinations thereof.

19. The beverage emulsion of claim 15, wherein said aqueous medium is at least partially evaporated to provide a particulate.

20. The beverage emulsion of claim 19 reconstituted in an aqueous medium.
